(19) United States
(12) Patent Application Publication
(10) Pub. No.: US 2026/0053090 A1
(43) Pub. Date: Feb. 26, 2026

(54) System and Method of Assisted Assembly of a Header in an Agricultural Harvester and Agricultural Harvester

(71) Applicant: CNH Industrial Brasil Ltda., Nova Lima (BR)

(72) Inventors: LEONARDO DOS SANTOS CARVALHO, Piracicaba-SP (BR); MARCO AURÉLIO RAMOS PEREIRA, Piracicaba-SP (BR); ÂNGELO DA SILVA, Piracicaba-SP (BR)

(21) Appl. No.: 19/105,529

(22) PCT Filed: Jul. 28, 2023
(86) PCT No.: PCT/BR2023/050244

§ 371 Date: Feb. 21, 2025

(30) Foreign Application Priority Data
Aug. 22, 2022 (BR) 1020220167265

(51) Int. Cl. A01D 41/127; A01D 45/10; A01D 47/00

(52) U.S. Cl. CPC A01D 41/1278; A01D 45/10; A01D 47/00

(57) ABSTRACT

A system and method enable the insertion and removal of a header in a harvesting machine in a simple and practical manner. In one aspect, a system for assisted assembly of a header on a combine harvester includes a camera, in which the captured images are sent to a multimedia center, a viewing support to provide a focus adjustment to the captured images, a sight grid, and a depth limiter.

### CROSS-REFERENCE TO RELATED APPLICATIONS

The present application is a US national phase entry of International Patent Application No. PCT/BR2023/050244, filed Jul. 28, 2023, which, in turn, is based upon and claims the right of priority to Brazilian Patent Application No. 1020220167265, filed Aug. 22, 2022, the disclosures of which are hereby incorporated by reference herein in their entireties for all purposes.

### FIELD OF THE INVENTION

The present invention relates, in general, to a system and method for assembling a header on a combine harvester and, more specifically, the invention is related to a system and method that enable the insertion and removal of the header on a harvesting machine in a simple and practical way, such as a sugarcane harvester.

### BACKGROUND OF THE INVENTION

Harvesting machines are known for various types of crops, such as sugarcane harvesting machines, grain harvesting machines and forage harvesters. These machines are generally intended to increase productivity in the harvesting of vegetable crops, such as, but not limited to, sugarcane, sweet sorghum, wheat, soybeans, corn, etc.

In the case of tall, stalky plants, such as sugarcane, energy cane and sweet sorghum, harvesters are machines designed to harvest this specific type of crop, due to its intrinsic characteristics. In this sense, the combine harvester generally has a fixed opening to receive and harvest the planting rows, which are generally spaced at relatively fixed and predetermined distances between them of 0.9 m or 1.5 m, or machines designed to harvest two rows simultaneously within these spacings. Optionally, the machine for harvesting these types of crops can also have a variable opening, to optionally harvest one or two planting rows with spacing of 0.9 m or 1.5 m between them, or planting rows with alternating spacing of 0.9 m and 1.5 m.

Sugarcane and sweet sorghum cultivation is undergoing significant evolution, both in terms of the development of new plant varieties and in terms of different planting configurations, always with a view to increasing productivity, both in relation to the quantity of tons harvested per hectare and in relation to the amount of alcohol and/or sugar produced per ton harvested.

Additionally, new agricultural equipment and implements are also being developed to optimize the harvest of this crop. In this sense, the insertion and removal of equipment and implements in agricultural machinery is still a laborious and time-consuming operation. The assembly and disassembly of these elements also require the work of several operators to handle them, which, in addition to entailing a high cost and greater risk of accidents involving the operators, impacts the productivity of the machine, since entirely manual operation keeps the machine idle for longer times.

Therefore, a need exists for systems and methods that enable the insertion and removal of an implement or header on a combine harvester in a simple and practical way, without the action of multiple operators. Additionally, a need exists for a combine harvester that supports such systems and methods.

In the state of the art there are some documents that deal with the installation and removal of accessories on agricultural machines or vehicles. However, none of these documents presents a simple, cheap and effective solution that can be used on different agricultural machines.

Document U.S. Pat. No. 11,212,953 B2 discloses a system for guiding a vehicle to connect it to an accessory using, among other elements, a sensor that emits steering angle signals to generate a path for vehicle guidance and a controller to emit presentation signals. This solution solves the problem of guiding a vehicle to install an accessory; however, the complexity of installing and assembling the system elements in the vehicle and/or its high cost make its use and application unfeasible in machinery already in operation or in agricultural activities with low investment capacity.

Another example of a solution for controlling the movement of a vehicle to couple it to an implement is document U.S. Pat. No. 9,880,560 B2, wherein the system requires a corrector for the images captured by the cameras for the system to be applicable. This solution also solves the problem of moving a vehicle to install an implement; however, this system depends on an on-board image corrector, and such sophistication makes it unfeasible to use and apply it to machinery that is already in operation and possibly has technological incompatibility or in agricultural activities with limited resources.

Therefore, there is a gap in the development for assisted assembly of an implement on a combine harvester that can be adaptable to equipment in use, with the use of few elements, cheap, efficient and that meets the user's needs.

### SUMMARY OF THE INVENTION

The features and advantages of the invention will be set forth, in part, in the following description, or may be obvious from the description, or may be learned through practice of the invention.

In various aspects, the present subject matter is directed to systems and/or methods for assisted assembly of a header on a combine harvester. Additionally, the present subject matter is also directed to a combine having the disclosed system.

In one aspect, a system for assisted header assembly on a combine harvester is presented, which includes an image capture camera, the camera being attached to the combine harvester and facing the header, wherein the captured images are sent to a multimedia center. The system also includes a viewing support to provide a focus adjustment to the images captured by the camera, the support surrounding the camera and being attached to the camera itself, a sight grid to guide the movement of the combine harvester, the grid being attached to the header, and a depth limiter to indicate an assembly position, the limiter being attached to the combine harvester.

According to additional or alternative embodiments of the system for assisted header assembly on a combine harvester of the present invention, the following features, and their possible variants, may also be present, alone or in combination:
the camera is attached to the central part of a combine harvester chassis;
the camera is attached to the chassis by means of an attachment structure, the attachment structure being articulated and allows the camera to be rotated;
the camera has at least one of infrared night vision or LED light, sound accessories and a broadcast antenna for connection to a remote control unit;
the multimedia center is located in the combine harvester or in a remote control unit; and
the depth limiter has at least one contact tab.

In another aspect, a method for assisted assembly of a header on a combine harvester is also presented. The method for assisted assembly of a header on a combine harvester has the following steps:
activating a camera of a system for assisted assembly, the camera being attached to the combine harvester, has a viewing support and is facing the header, and wherein the camera captures images that are sent and displayed on a multimedia center;
identifying, in the captured images, a sight grid being attached to the header to align it with the viewing support of the camera;
moving the combine harvester towards the header based on the alignment of the viewing support of the camera with the sight grid;
stopping the movement of the combine harvester when a depth limiter attached to the combine harvester comes into contact with the header; and
securing the header to the combine harvester.

According to additional or alternative embodiments of the method for assisted assembly of a header on a combine harvester of the present invention, the following features, and their possible variants, may also be present, alone or in combination:
the steps of activating the camera, identifying the sight grid, moving the combine harvester and stopping the movement of the combine harvester are determined locally, in a cabin of the operator of the combine harvester, or remotely, in a remote control unit; and
the step of securing the header to the combine harvester can be carried out manually by an operator.

Additionally, a combine harvester is presented having a header, a chassis mounted on wheels or tracks, a drive engine, a cabin of the operator, a primary extractor, a set of conveyor rollers and a secondary extractor and discharge opening. The combine harvester includes a camera for capturing images of the header being secured at the center of the front part of the chassis, a viewing support surrounding the camera and being attached to the camera itself, a sight grid attached to the header and an assembly depth limiter, the limiter attached to the front part of the chassis.

According to additional or alternative embodiments of the combine harvester of the present invention, the harvester may be a sugarcane harvesting machine.

These and other aspects, functions and advantages of the present invention will become better understood by reference to the following description and appended claims. The accompanying drawings, which are incorporated into and constitute a part of this specification, illustrate embodiments of the invention and, together with the description, serve to explain the principles of the invention.

### BRIEF DESCRIPTION OF THE FIGURES

A complete and feasible description of the present invention, which includes the best mode thereof, directed to a person skilled in the art, is presented in the specification, which makes reference to the attached figures, in which:

FIG. 1 shows a side view of an embodiment of a combine harvester in accordance with aspects of the present disclosure;

FIGS. 2a and 2b illustrate the front of an embodiment of the combine harvester and an enlarged view of an embodiment of a system of the present invention, respectively, in accordance with aspects of the present disclosure;

FIGS. 3a and 3b show an embodiment of an image capture camera and a viewing support, in accordance with aspects of the present disclosure;

FIG. 4 shows the viewing support and a sight grid of the system, in accordance with aspects of the present disclosure;

FIG. 5 illustrates the front of a combine harvester with depth limiters of the system installed on the harvester chassis, in accordance with aspects of the present disclosure;

FIGS. 6a and 6b show two illustrative embodiments of the depth limiters of the present invention, in accordance with aspects of the present disclosure; and

FIGS. 7 and 8 show an installation position of the sight grid on the header, in accordance with aspects of the present disclosure.

### DETAILED DESCRIPTION OF THE INVENTION

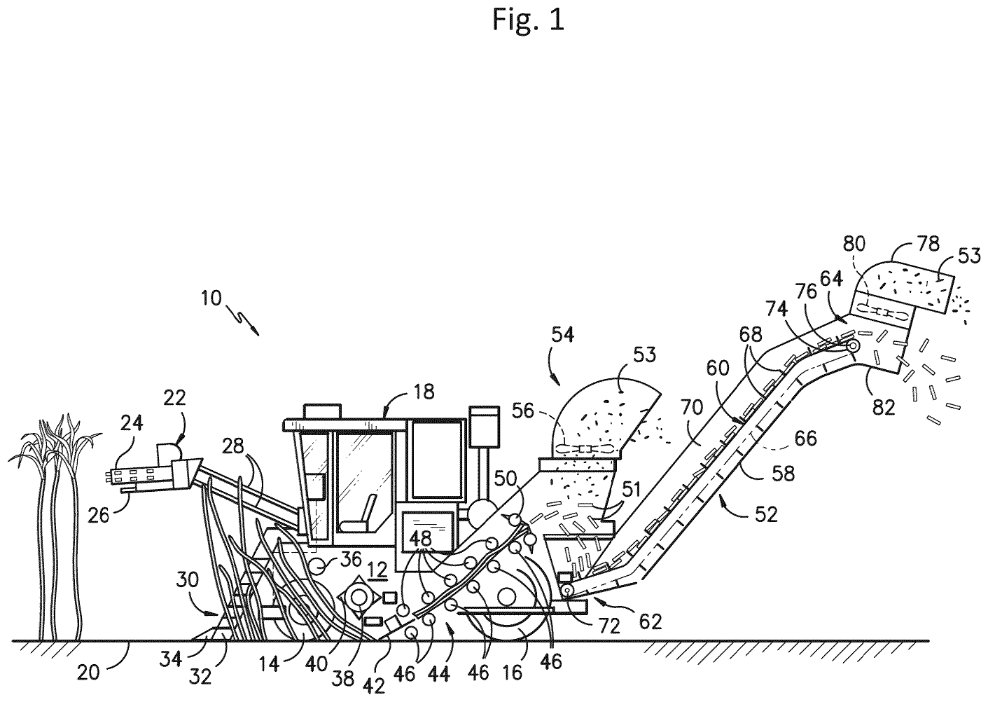

The invention will now be described with respect to its particular embodiments, with reference to the attached figures. These figures are schematic, and their dimensions and/or proportions may not correspond to reality, since they are intended to describe the invention in a didactic manner. Furthermore, certain known and common construction details may have been omitted for greater clarity and conciseness of the description that follows. The reference numerals used are repeated throughout the figures to identify identical or similar parts. Any terms used such as “above”, “below”, “front”, “back”, “right”, “left” etc. and their variants must be interpreted according to the guidance given in FIG. 1.

Turning now to the drawings, FIG. 1 illustrates a side view of one embodiment of a combine harvester 10 in accordance with aspects of the present disclosure. As shown, the combine harvester 10 is configured as a sugarcane harvester. However, in other embodiments, the combine harvester 10 may be any suitable combine harvester known in the art.

As shown in FIG. 1, the combine harvester 10 includes a chassis 12, a pair of front wheels 14, a pair of rear wheels 16, and a cabin of the operator 18. The combine harvester 10 may also include a primary power source (e.g., a chassis-mounted engine 12) that powers one or both pairs of wheels 14, 16 via a transmission (not shown). Alternatively, the combine harvester 10 may be a track-driven combine and, therefore, it may include tracks driven by the drive mechanism in replacement of the illustrated wheels 14, 16. The drive mechanism may also drive a hydraulic fluid pump (not shown) configured to generate pressurized hydraulic fluid to drive various hydraulic components of the combine harvester 10.

Additionally, the combine harvester 10 may include various components for cutting, processing, cleaning, and unloading sugarcane as the cane is harvested from an agricultural field 20. For example, the combine harvester 10 may include a tip cutter assembly 22 positioned on the its front end to intercept sugarcane as the combine harvester 10 is moved in the forward direction. As shown, the tip cutter assembly 22 may include both a binding disc 24 and a cutting disc 26. The binding disc 24 can be configured to gather sugarcane stalks so that the cutter disk 26 can be used to cut the tip of each stalk. Generally, the height of the tip cutter assembly 22 may be adjustable by means of a pair of arms 28 hydraulically raised and lowered as desired by the operator.

Additionally, the combine harvester 10 may include a row divider 30 that extends upward and rearward from the field 20. In general, the row divider 30 may include two spiral feed rollers 32, also known as a “lollipop”. Each feed roller 32 may include a soil shoe 34 as its lower end assists the row divider 30 in separating sugarcane stalks for harvest. Furthermore, as shown in FIG. 1, the combine harvester 10 may include a knock-down roller 36 positioned near the front wheels 14 and a roller with projections 38 positioned behind the knock-down roller 36. As the knock-down roller 36 is rotated, harvested sugarcane stalks are knocked-down while the row divider 30 gathers the stalks from the crop field 20 into the machine 10. Additionally, as shown in FIG. 1, the roller with projections 38 may include a plurality of intermittently mounted vanes 40 which assist in forcing the sugarcane stalks down. As the roller 38 is rotated during harvesting, the sugarcane stalks that were knocked-down by the knock-down roller 36 are separated and subsequently knocked-down by the roller 38 as the combine harvester 10 continues to be moved forward with respect to the field 20.

Further referring to FIG. 1, the combine harvester 10 may also include a base cutting assembly 42 positioned behind the roller 38. As is generally understood, the base cutting assembly 42 may include blades (not shown) for cutting the stalks of sugarcane as the cane is harvested. The blades, located on the periphery of the assembly 42, can be rotated by a hydraulic engine (not shown) driven by the hydraulic system of the vehicle. Additionally, in various embodiments, the blades may be angled downward to cut the base of the sugarcane as the cane is knocked-down by the roller 38.

Additionally, the combine harvester 10 may include an assembly of one or more conveyor rollers 44 located downstream of the base chopping assembly 42 to move the cut stalks of sugarcane from the base cutting assembly 42 along the processing trajectory. As shown in FIG. 1, the conveyor roller assembly 44 may include a plurality of lower rollers 46 and a plurality of upper rollers 48. As the sugarcane is conveyed across the conveyor roller assembly 44, waste (e.g., rocks, dirt, and/or the like) may also be conveyed or fall through the lower rollers 46 onto the field 20.

Additionally, the combine harvester 10 may include a chopper assembly 50 located at the downstream end of the conveyor roller assembly 44 (e.g., adjacent to the rearmost lower and upper conveyor rollers 46, 48). In general, the chopper assembly 50 may be used to cut or chop harvested sugarcane stalks into smaller pieces or “fragments” 51 that may, for example, measure 15.24 centimeters (six (6) inches), also called billets or stalk sections. The fragments 51 can then be propelled towards a lifting assembly 52 of the combine harvester 10 to be collected in an external receiver or storage device (not shown).

As is generally understood, pieces of waste 53 (e.g., dust, dirt, leaves, etc.) separated from the sugarcane fragments 51 may be expelled from the combine harvester 10 through a primary extractor 54, which is located behind the chopper assembly 50 and is oriented to direct waste 53 out of the combine harvester 10. Additionally, a fan 56 may be mounted on the primary extractor 54 to generate a suction force or vacuum sufficient to capture the waste 53 and forcing the waste 53 through the primary extractor 54. The waste 53 is then directed outward and, generally in the opposite direction of the combine harvester 10 through an outlet of the primary extractor 54. The separated fragments 51 and those heavier than the waste 53 being expelled from the extractor 54 can then fall onto the lifting assembly 52.

As shown in FIG. 1, the lifting assembly 52 may generally include a lift housing structure 58 and a lift 60 extending within said lift housing structure 58 between a lower proximal end 62 and an upper distal end 64. In general, the lift 60 may include a chain or conveyor belt 66 and a plurality of paddles or flights 68 coupled to or evenly spaced on the chain 66. The flights 68 may be configured to hold the sugarcane fragments 51 on the lift 60 as the fragments 51 are raised to the top of the lift 70. Additionally, the lift 60 may include lower and upper sprockets 72, 74 positioned around the proximal and distal ends 62, 64, respectively. As shown in FIG. 1, a lift engine 76 may be coupled to one of the sprockets (e.g., the upper sprocket 74) to drive the chain 66, thereby allowing the chain 66 and flights 68 to travel in an endless cycle between the proximal and distal ends 62, 64 of the lift 60.

Furthermore, pieces of waste 53 (e.g., dust, dirt, leaves, etc.) separated from the sugarcane fragments 51 may be expelled from the combine harvester 10 through a secondary extractor 78 coupled to the rear end of the lift 58. As shown in FIG. 1, the secondary extractor 78 may be situated adjacent the distal end 64 of the lift 60 and may be oriented to direct waste 53 outward from the combine harvester 10. Additionally, a fan 80 may be mounted on the secondary extractor 78 to generate a suction force or vacuum sufficient to extract the waste 53 and force the waste 53 through the secondary extractor 78. The separated fragments 51 heavier than the waste 53 expelled through the extractor 78 may then fall from the distal end 64 of the lift 60. Typically, fragments 51 may fall through a discharge opening 82 of the lifting assembly 52 into an external storage device (not shown), such as a car, a transshipment, a dumpster, etc.

During operation, the combine harvester 10 travels across the entire agricultural field 20 to harvest sugarcane. After the height of the tip cutter 22 is set (if used) by means of the arms 28, the binding disc 24 in the tip cutter assembly 22 can be operated to bind the sugarcane tips as the combine harvester 10 goes through the field 20, while the cutting disc 26 cuts the leafy ends of the sugarcane stalks to dump them along both sides of the combine harvester 10. As the stalks enter the row divider 30, the shoes 34 can configure the width of the operation to determine the amount of sugarcane that enters the throat of the combine harvester 10, either in a fixed or adjustable way. The lollipops 32 then agglutinate the stalks at the machine inlet to allow the knock-down roller 36 to bend the stalks downward in conjunction with the action of the feed roller 38. Since the stalks are positioned at an angle as shown in FIG. 1, the base cutting assembly 42 can then cut the base of the field stalks 20. The cut stalks are then directed to the conveyor roller assembly 44.

The cut stalks of sugarcane are transported backwards by conveyor rollers 46, 48 which compress the stalks and harvested matter. At the downstream end of the conveyor roller assembly 44, the chopper assembly 50 cuts or chops the compacted sugarcane stalks into pieces or fragments 51. Conveyed waste 53 (e.g., dust, dirt, leaves, etc.) separated from the sugarcane fragments 51 are then extracted through the primary extractor 54 using the suction created by the fan 56. The separated/washed fragments 51 then fall to the lifting assembly 52 and travel upward through the lift 60 from its proximal end 62 to its distal end 64. During normal operation, once the fragments 51 reach the distal end 64 of the lift 60, the fragments 51 fall through the discharge opening 82 up to an external storage device. Similar to the primary extractor 54, waste is blown out of the combine harvester 10 through the secondary extractor 78 with the aid of the extractor fan 80.

In general, the embodiment of the present invention provides a system and a method for assembling a header that enables the insertion and removal of the header in a combine harvester, alternatively the combine harvester 10. However, in other embodiments, the combine harvester 10 may correspond to any suitable combine harvester known in the art.

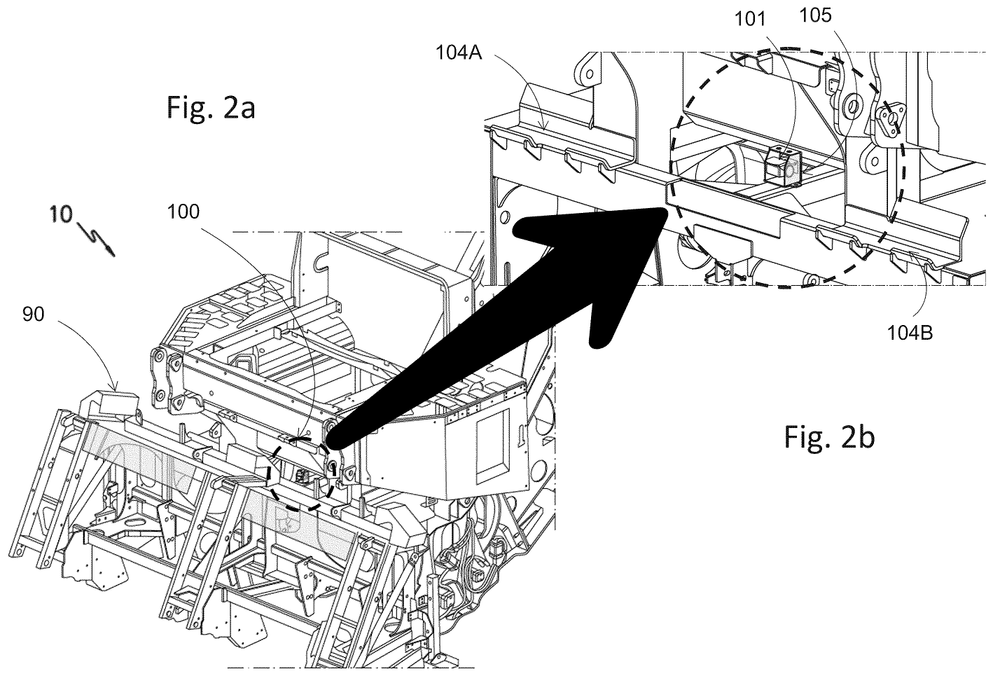

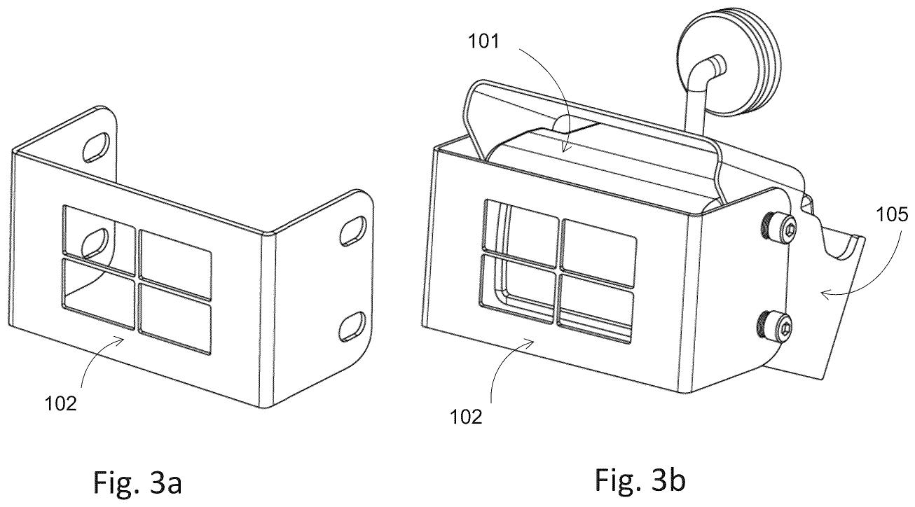

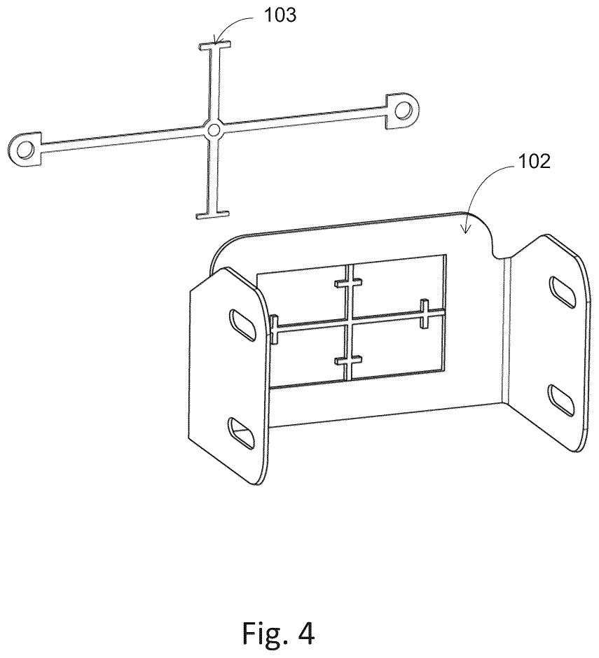

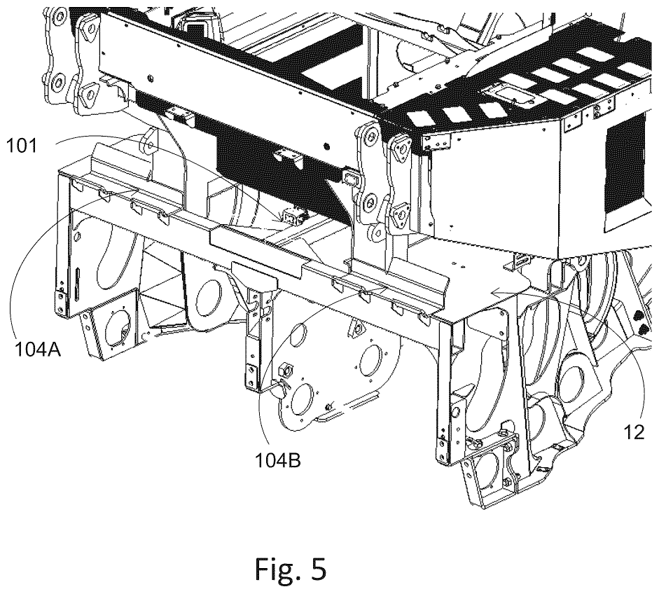

Specifically, FIGS. 2a and 2b show the present system, which is a system for assisted assembly 100 of header 90 on a combine harvester 10, which has an image capture camera 101, the camera being attached to the combine harvester 10 and facing the header 90, wherein the captured images are sent to a multimedia center. The system further includes a viewing support 102, illustrated in FIGS. 3a and 3b, to provide a focus adjustment to the images captured by the camera 101, the support 102 surrounding the camera 101 and being attached to the camera 101 itself. The system also includes a sight grid 103 to guide the movement of the combine harvester 10, as shown in FIG. 4, the grid 103 being attached to the header 90, and a depth limiter 104A, 104B to indicate an assembly position, the limiter 104A, 104B being attached to the combine harvester 10, as shown in FIG. 5.

In this way, an operator, in a combine cabin or at a remote control unit, can see the coupling between the header 90 and the combine harvester 10, without the need for other operators working with the combine harvester to guide this contact. It should be noted that movement around the header 90 is one of the most important actions for a good installation, which generally requires the action of two or more operators, which can lead to a greater risk of accidents and also requires more communication and operation time, negatively affecting the productivity of the machine.

The camera 101 is attached to the central part of a chassis 12 of the combine harvester 10, and can be attached to the chassis 12 by means of an articulated attachment structure 105 that allows the camera 101 to be rotated, shown in FIG. 3b. The articulation of the attachment structure 105 allows adjustments to be made to adjust and align the position of the camera 101. The camera 101 can be a vehicle camera and have at least one of infrared night vision or LED light, sound accessories and a broadcast antenna for connection to a remote control unit. The night vision allows the installation and assembly of the header 90 on the combine harvester 10 to be carried out at night and the sound accessories indicate the proximity of the combine harvester 10 to the header 90.

The multimedia center (not shown in the figures) may be in a remote control unit located outside the combine harvester. The images captured by the camera 101 may be transmitted to the multimedia center through a wireless communication connection, by means of a broadcast antenna.

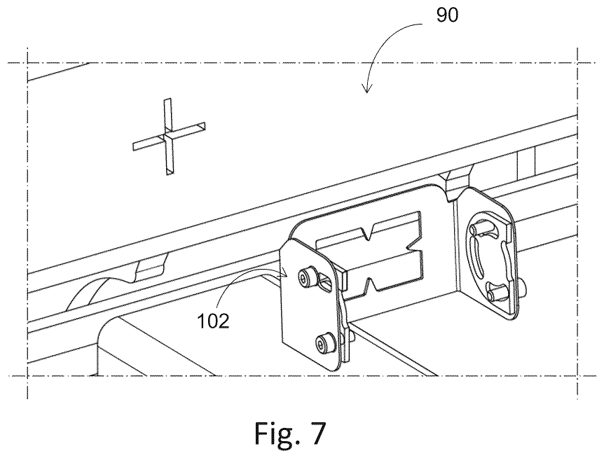

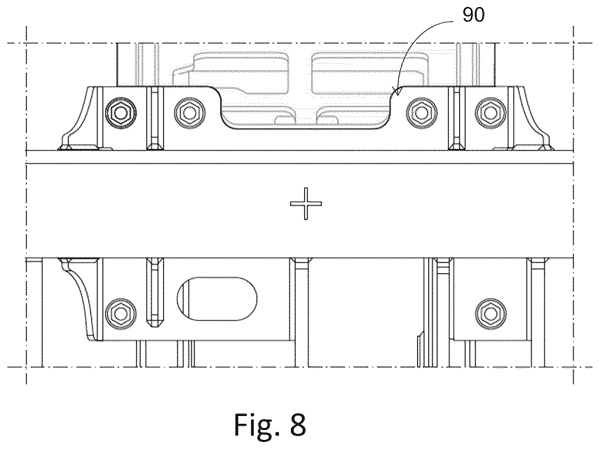

The sight grid 103 is installed on the header 90 and faces the combine harvester 10, at a location within the image capture range of the camera 101, as indicated by “+” in FIGS. 7 and 8, so that the grid 103 is aligned horizontally with the viewing support 102.

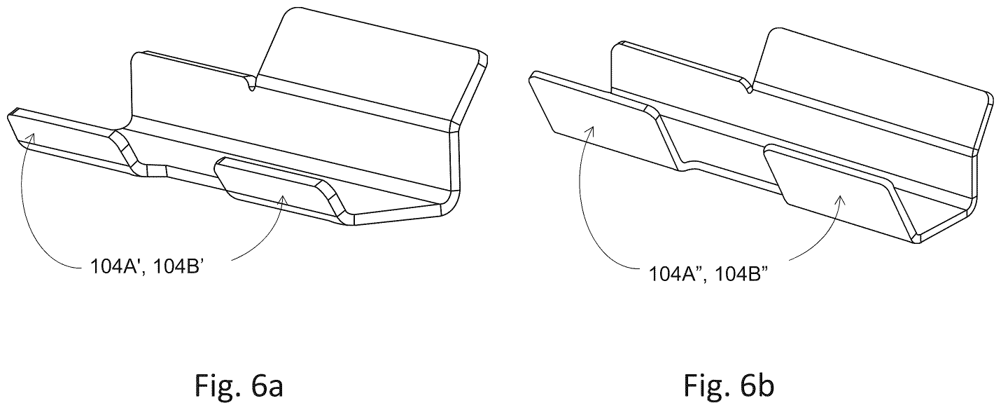

The depth limiter 104A, 104B is installed on the chassis 12 of the combine harvester 10 to define the assembly position and indicate the moment to stop the movement of the combine harvester 10. The limiter 104A, 104B has at least one contact tab 104A′, 104B′, 104A″, 104B″ that can have different sizes according to the assembly position of the header, as represented in FIGS. 6a and 6b, and a person skilled in the art will readily identify the necessary size of the contact tabs in relation to the header to be assembled. In an alternative embodiment of the present invention, two depth limiter 104A, 104B are installed for better leveling and greater precision of the assembly position.

The system for implementing the present invention can be installed and used on machines already in operation and also contributes to the maintenance activity of the header. Real-time visualization of the internal part of the header allows the operator to identify any damage or wear on the header, which allows the header to be replaced at an appropriate time, avoiding possible problems or adversities during work.

The embodiment of the present invention also relates to a method for assisted header assembly on a combine harvester. The method includes the steps of:
activating a camera 101 of a system for assisted assembly 100, the camera 101 being attached to the combine harvester 10, has a viewing support 102 and is facing the header 90, wherein the camera 101 captures images that are sent and displayed on a multimedia center;
identifying, in the captured images, a sight grid 103 being attached to the header 90. The identification is aimed at the alignment of the viewing support 102 of the camera 101 with the sight grid 103;
moving the combine harvester 10 toward the header 90 based on the alignment of the viewing support 102 of the camera 101 with the sight grid 103;
stopping the movement of the combine harvester 10 when a depth limiter 104A, 104B, which is attached to the combine harvester 10, comes into contact with the header 90; and
securing the header 90 to the combine harvester 10.

Alternatively, the steps of the present method of activating the camera 101, identifying the sight grid 103, moving the combine harvester 10 and stopping the movement of the combine harvester 10 may be determined locally, in a cabin of the operator 18 of the combine harvester 10, or remotely, in a remote control unit (not shown in the figures). Optionally, the media center may be in a remote control unit located outside the combine harvester, for example, in a server located at a farm headquarters or in a cloud computing provider. The images captured by the camera 101 may be broadcasted to the media center via a wireless communication connection, by means of a broadcast antenna. The media center may be configured to receive and broadcast appropriate control signals to the combine harvester 10 to perform certain steps, thereby allowing the media center to actively control the method. For example, the multimedia center can control the activation of the camera 101 to capture images of the header 90, receive and display the images captured from the header 90 and identify, or locate, by means of a conventional image recognition tool, the sight grid 103 attached to the header 90. Similarly, the multimedia center can control the movement of the combine harvester 10. In addition, the multimedia center can also control the attachment structure 105 to make adjustments to the regulation and alignment of the position of the camera 101. In this way, the multimedia center can conduct the steps in an automated manner, without the need for an operator. The step of securing the header 90 to the combine harvester 10 can be performed manually by an operator.

In this sense, it was found that the method of carrying out the present invention reduces the number of operators involved in inserting and removing headers on agricultural machines.

The embodiment of the present invention also features a combine harvester having a header 90, a chassis 12 mounted on wheels or tracks 14, 16, a drive engine, a cabin of the operator 18, a primary extractor 54, a set of conveyor rollers 44, a secondary extractor 78, and discharge opening 82. The combine harvester further includes a camera 101 for capturing images of the header 90 being secured to the center of the front of the chassis 12, a viewing support 102 surrounding and attached to the camera 101, a sight grid 103 being attached to the header 90, and an assembly depth limiter 104A, 104B being attached to the front of the chassis 12.

In an alternative embodiment, the combine harvester is a machine for harvesting sugarcane.

The new system and method for assisted header assembly on a combine harvester and the combine harvester of the present invention have a combination of operational and commercial advantages, such as:
simple, cheap and effective solution, which can be adapted and used in machines already in operation, and with the use of few elements;
can be applied to different types of headers and agricultural machines for different types of crops and according to the user's needs;
the insertion and removal of a header on a machine can be performed by just one operator; and
real-time viewing of the header allows the identification of any damage or wear on the header, enabling the header to be replaced at the most appropriate time and avoiding possible problems during work.

Thus, the implementation of the present invention provides a solution for improving the insertion and removal of agricultural headers and optimizing harvesting, in addition to a new combine harvester comprising the solution.

This written description uses examples to describe the invention, including the best mode, and also to enable a person skilled in the art to practice the invention, including making and using any devices or systems and performing any methods embodied therein. The patentable scope of the invention is defined by the claims and may include other examples that occur to those skilled in the art. Such other examples are intended to be within the scope of the claims if they include structural elements that do not differ from the literal language of the claims, or if they include equivalent structural elements that differ insubstantially from the literal language of the claims.

1-11. (canceled)

12. A system for assisted assembly of a header on a combine harvester, the system comprising:
an image capture camera, the camera attached to the combine harvester and facing the header, wherein captured images are sent to a multimedia center;
a viewing support configured to provide a focus adjustment to images captured by the camera, the viewing support surrounding and attached to the camera;
a sight grid configured to guide the movement of the combine harvester, the sight grid attached to the header; and
a depth limiter configured to indicate an assembly position, the depth limiter attached to the combine harvester.

13. The system of claim 12, wherein the camera is attached to a central part of a chassis of the combine harvester.

14. The system of claim 13, wherein the camera is attached to the chassis by an attachment structure, the attachment structure being articulated and configured to allow the camera to be rotated.

15. The system of claim 12, wherein the camera has at least one of infrared night vision or an LED light, sound accessories, or a broadcast antenna for connection to a remote control unit.

16. The system of claim 12, wherein the multimedia center is located on the combine harvester or on a remote control unit.

17. The system of claim 12, wherein the depth limiter has at least one contact tab.

18. A method for assisted assembly of a header on a combine harvester, the method comprising:
activating a camera attached to the combine harvester, the camera having a viewing support and facing the header, and wherein the camera captures images that are sent and displayed on a multimedia center;
identifying, in the captured images, a sight grid attached to the header to align it with the viewing support of the camera;
moving the combine harvester towards the header based on the alignment of the viewing support of the camera with the sight grid;
stopping the movement of the combine harvester when a depth limiter attached to the combine harvester comes into contact with the header; and
securing the header to the combine harvester.

19. The method of claim 18, wherein the steps of activating the camera, identifying the sight grid, moving the combine harvester, and stopping the movement of the combine harvester are determined locally, in a cabin of an operator of the combine harvester, or remotely, in a remote control unit.

20. The method of claim 18, wherein securing the header to the combine harvester is performed manually by an operator.

21. A combine harvester including a header, a chassis mounted on wheels or tracks, a drive engine, a cabin of an operator, a primary extractor, a set of conveyor rollers, a secondary extractor, and a discharge opening, the combine harvester further comprising:
a camera configured to capture images of the header attached to a center of a front part of the chassis;
a viewing support that surrounds and is attached to the camera;
a sight grid attached to the header; and
an assembly depth limiter attached to the front of the chassis.

22. The combine harvester of claim 21, wherein the combine harvester is a sugarcane harvester.
